(19) United States
(12) Patent Application Publication
(10) Pub. No.: US 2007/0147266 A1
(43) Pub. Date: Jun. 28, 2007

(54) Apparatus and method for determining receipt of a sent packet

(76) Inventors: Rainer Walter Bachl, Nuremberg (DE); Francis Dominique, Rockaway, NJ (US); Hongwei Kong, Denville, NJ (US); Walid E. Nabhane, Bedminster, NJ (US)

Correspondence Address: HARNESS, DICKEY & PIERCE, P.L.C., P.O. BOX 8910, RESTON, VA, 20195, US

(21) Appl. No.: 11/318,465

(22) Filed: Dec. 28, 2005

(51) Int. Cl. H04J 1/16

(52) U.S. Cl. 370/252; 370/412

(57) ABSTRACT

A receiver and method thereof for determining if a sent packet was properly received. The method includes buffering more than one response message received in response to the sent packet and using the buffered response messages to determine if the packet was properly received.

### BACKGROUND OF THE INVENTION

A cellular communications network typically includes a variety of communication nodes coupled by wireless or wired connections and accessed through different types of communications channels. Each of the communication nodes includes respective protocol stacks that process the data respectively transmitted and received over the communications channels. Depending on the type of communications system, the operation and configuration of the various communication nodes can differ and are often referred to by different names. Such communications systems include, for example, a Code Division Multiple Access 2000 (CDMA2000) system and a Universal Mobile Telecommunications System (UMTS).

Third generation wireless communication protocol standards (e.g., 3GPP-UMTS, 3GPP2-CDMA2000, etc.) may employ a dedicated traffic channel in the uplink (UL) (e.g., a communication flow from a mobile station (MS) or User Equipment (UE) to a base station (BS) or NodeB). The dedicated channel may include a data part (e.g., a dedicated physical data channel (DPDCH) in accordance with UMTS Release 4/5 protocols, a fundamental channel or supplemental channel in accordance with CDMA2000 protocols, etc.) and a control part (e.g., a dedicated physical control channel (DPCCH) in accordance with UMTS Release 4/5 protocols, a pilot/power control sub-channel in accordance with CDMA2000 protocols, etc.).

Newer versions of these standards, for example, Release 6 of UMTS provide for high data rate uplink channels referred to as enhanced dedicated channels (E-DCHs). An E-DCH may include an enhanced data part (e.g., an E-DCH dedicated physical data channel (E-DPDCH) in accordance with UMTS protocols) and an enhanced control part (e.g., an E-DCH dedicated physical control channel (E-DPCCH) in accordance with UMTS protocols).

FIG. 1 illustrates a conventional wireless communication system 100 operating in accordance with UMTS protocols. Referring to FIG. 1, the wireless communication system 100 may include a number of NodeBs such as NodeBs 120, 122 and 124, each serving the communication needs of a first type of user 110 and a second type of user 105 in their respective coverage area. The first type of user 110 may be a higher data rate user such as a UMTS Release 6 user, and the second type of user 105 may be a lower data rate user such as a UMTS Release 4/5 user. The NodeBs are connected to a radio network controller (RNC) such as RNCs 130 and 132, and the RNCs are connected to a Mobile Switching Center/Serving GPRS Support Node (MSC/SGSN) 140. The RNC handles certain call and data handling functions, such as, autonomously managing handovers without involving MSCs and SGSNs. The MSC/SGSN 140 handles routing calls and/or data to other elements (e.g., RNCs 130/132 and NodeBs 120/122/124) in the network or to an external network. Further illustrated in FIG. 1 are interfaces Uu, Iub, Iur and Iu between these elements.

Each UE maintains an active set of NodeBs with which the UE has some form of active communication in a manner that is well-known in the art. For example, each UE may receive and/or modify an active set of NodeBs based on information received from an RNC, such as RNC 130 and 132 illustrated in FIG. 1. One of the NodeBs in the active set is a serving NodeB, and the serving NodeB serves the communication needs of the UE. The other NodeBs in the active set do not have primary responsibility for serving the communication needs of the UE and are referred to as non-serving NodeBs. Because non-serving NodeBs do not have the primary responsibility for serving the communication needs of the UE, the probability that a non-serving NodeB fails to detect, for example, an E-DCH packet sent from a UE is greater than the probability that the serving NodeB fails to detect an E-DCH packet sent from a UE.

Current 3GPP standards use an E-DCH Hybrid ARQ Indicator Channel (E-HICH) to carry acknowledgement (ACK) or non-acknowledgement (NACK) information for informing the UE if the uplink (UL) transmitted E-DCH packet was received and decoded correctly by a NodeB. The ACK/NACK information is sent in response messages often called an ACK or NACK as well. An ACK indicates that the data packet was detected, received and decoded correctly; and a NACK indicates that the data packet was detected, but not received and/or decoded correctly.

A serving NodeB generates an ACK if the serving NodeB detects, receives and decodes an E-DCH packet sent from a UE correctly. The serving NodeB generates a NACK if the serving NodeB detects an E-DCH packet sent from a UE, but fails to receive and/or decode the E-DCH packet sent from the UE correctly. Further, the serving NodeB remains silent if the serving NodeB fails to detect an E-DCH packet sent from a UE.

A non-serving NodeB generates an ACK if an E-DCH packet sent from a UE is detected, received and decoded correctly by the non-serving NodeB. However, the non-serving NodeB remains silent and does not generate a NACK if the non-serving NodeB detects an E-DCH sent from a UE, but fails to receive and/or decode the E-DCH packet correctly. Further, the non-serving NodeB remains silent and does not generate a NACK if the non-serving NodeB fails to detect an E-DCH packet sent from a UE. Accordingly, unless a non-serving NodeB detects, receives, and decodes an E-DCH sent from a UE correctly, the non-serving NodeB remains silent.

FIG. 2 illustrates a portion of a prior art transmitter 300 located at a NodeB, for example NodeBs 120/122/124, of FIG. 1 for sending ACK/NACK information on the E-HICH. FIG. 2 further illustrates a portion of a prior art receiver 350 located at a UE, for example UE 110, of FIG. 1 for receiving and processing ACK/NACK information on the E-HICH. The operations performed by the NodeB transmitter 300, UE receiver 350, and subcomponents thereof shown in FIG. 2 are well-known in the art and thus, will only briefly be discussed herein for the sake of brevity.

As shown in FIG. 2, at the transmitter 300, a mapping unit 301 maps ACK/NACK information received from, for example, an E-DCH HARQ indicator. The mapping unit 301 of the serving NodeB maps an ACK as a +1; maps a NACK as a −1; and maps a 0 if the serving NodeB remains silent. The mapping unit 301 of a non-serving NodeB maps an ACK as a +1 and maps a 0 if the non-serving NodeB remains silent. An orthogonal signal sequence unit 303 modulates a mapped signal received from the mapping unit 301 using an orthogonal signature sequence and outputs a signal to a modulator/spreading unit 304. The modulator/spreading unit 304 QPSK-modulates, spreads, and outputs the signal to a gain unit 315. The gain unit 315 adjusts the gain of the signal received from the modulator/spreading unit 304.

Further, as shown in FIG. 2, an orthogonal spreading unit 310 spreads a common pilot channel (CPICH) and outputs the spread signal to a gain unit 316. The gain unit 316 adjusts the gain of the received signal.

A modulator 306 modulates other downlink channels and outputs the modulated signal to an orthogonal spreading unit 311. The orthogonal spreading unit 311 spreads the modulated signal and outputs the spread signal to a gain unit 317. The gain unit 317 adjusts the gain of the signal received from the orthogonal spreading unit 311.

A combiner unit 320 combines (e.g., code-division and/or I/Q multiplex) the outputs of each of the gain units 315, 316 and 317 into a combined signal. A scrambling and shaping filter 325 scrambles and filters the combined signal. The output of the scrambling and shaping filter 325 is sent to the receiver 350 via a propagation channel 330 (e.g., over the air).

At the prior art receiver 350, the sent signal is received over the propagation channel 330. A channel estimation unit 355 generates channel estimates using the CPICH in the received signal. A noise power estimation unit 360 estimates the noise power from the CPICH. A descrambling/dispreading/derotation unit 345 uses the channel estimates to de-rotate the E-HICH. The E-HICH descrambling/despreading/derotation unit 345 also despreads and descrambles the E-HICH to generate soft symbol metrics. The soft symbol metrics are output to an energy-based E-HICH DTX detection unit 365, which also receives the noise power from the noise power estimation unit 360. The E-HICH DTX detection unit 365 may detect the E-HICH by calculating the SIR (which may be the ratio of the square of soft symbol metric over the noise power) and comparing the SIR with a threshold. Once the E-HICH is detected by the E-HICH DTX detection unit 365, the sign of the soft symbol metric may further be used to determine whether an ACK or a NACK is received if the NodeB is a serving NodeB.

As described above, the E-HICH carries ACK/NACK information generated by NodeBs. The UE generally monitors the E-HICH after sending an E-DCH packet. As is well known in the art, if a UE detects ACK information from any of the NodeBs in the active set, the UE will not resend the E-DCH packet; and if the UE detects NACK information or no response on the E-HICH for a specified duration, the UE will resend the E-DCH packet.

A false alarm is if a UE judges that ACK information was received from a NodeB, but the NodeB did not send ACK information. A false alarm may result in a lost data packet because the sent E-DCH packet was not received and decoded correctly by a NodeB and the UE does not resend the E-DCH packet. Therefore, reducing the probability of false alarms at the UE is desirable. Further, the probability that a UE detects an ACK if a NACK is sent by a NodeB should also be lowered to avoid losing packet data.

As described above, there may be several non-serving NodeBs for a particular UE. Conventionally, the total probability of a false alarm associated with non-serving NodeBs should not exceed the probability of a false alarm associated with the serving NodeB. Accordingly, the false alarm probability associated with each non-serving NodeB should be approximately one order of magnitude smaller than the false alarm probability associated with the serving NodeB. In order to accomplish this, conventionally non-serving NodeBs use more power than the serving NodeB to send an ACK if a conventional receiver is used in a UE to detect response messages (e.g., ACK/NACK information) sent from the NodeBs.

### SUMMARY OF THE INVENTION

One or more example embodiments of the present invention are directed towards improving the detection of response messages received in response to a sent packet.

An example embodiment of the present invention provides a method of determining receipt of a sent packet. The method includes buffering more than one response message received from a non-serving network station in response to the sent packet, and determining whether the transmitted packet was properly received based on the buffered response messages. Each response message indicates whether the non-serving network station sending the response message properly received the sent packet.

An example embodiment of the present invention provides an apparatus for determining receipt of a sent packet. The apparatus includes a buffering device buffering more than one response message received from a non-serving network station in response to the sent packet and determining whether the sent packet was properly received based on the buffered response messages.

According to one or more example embodiments of the present invention, the probability of false alarm per transmission of a packet is relaxed by buffering more than one ACK received from any of the non-serving NodeBs and using the buffered ACKs to determine whether a non-serving NodeB properly received a packet transmitted from the UE. Further, the power on a downlink channel used by a non-serving NodeB to transmit a response message may be reduced if one or more example embodiments of the present invention are used to detect the response message, while the probability of a false alarm remains the same as in a conventional receiver.

Accordingly, one or more example embodiments of the present invention may improve detection performance of a receiver, thereby improving system performance and achieving significant capacity gain with a negligible increase in receiver complexity.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limiting of the present invention and wherein:

FIG. 1 illustrates a prior art wireless communication system operating in accordance with UMTS protocols;

FIG. 2 illustrates portions of a prior art transmitter and portions of a prior art receiver;

FIG. 3 illustrates portions of a receiver according to an example embodiment of the present invention;

FIG. 4 illustrates portions of a receiver according to another example embodiment of the present invention;

FIG. 5 illustrates a flow chart of a method of determining receipt of a sent packet according to an example embodiment of the present invention; and

FIG. 6 illustrates a portion of a flow chart of a method of determining receipt of a sent packet according to another example embodiment of the present invention.

### DETAILED DESCRIPTION OF EXAMPLE EMBODIMENTS

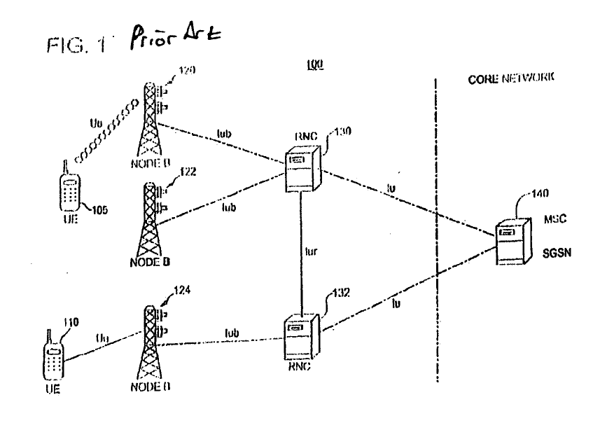

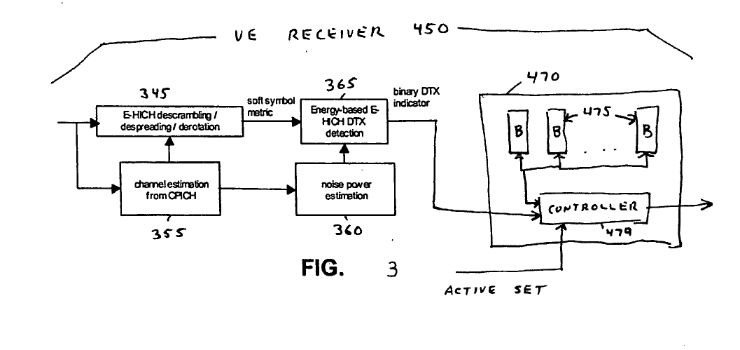

FIG. 3 illustrates a relevant portion of a receiver 450 according to an example embodiment of the present invention. The receiver 450 may be located at, for example, any or all UEs using an E-DCH, for example UE 110 shown in FIG. 1. Example embodiments of the present invention will be discussed with regard to the conventional wireless system of FIG. 1; however, it will be understood that example embodiments of the present invention may be implemented in conjunction with any suitable wireless telecommunications network (e.g., UMTS, CDMA2000, etc.).

As shown in FIG. 3, a receiver 450 according to an example embodiment of the present invention includes the E-HICH descrambling/despreading/derotation unit 345, the channel estimation unit 355, the noise power estimation unit 360, the energy-based E-HICH DTX detection unit and a buffering device 470.

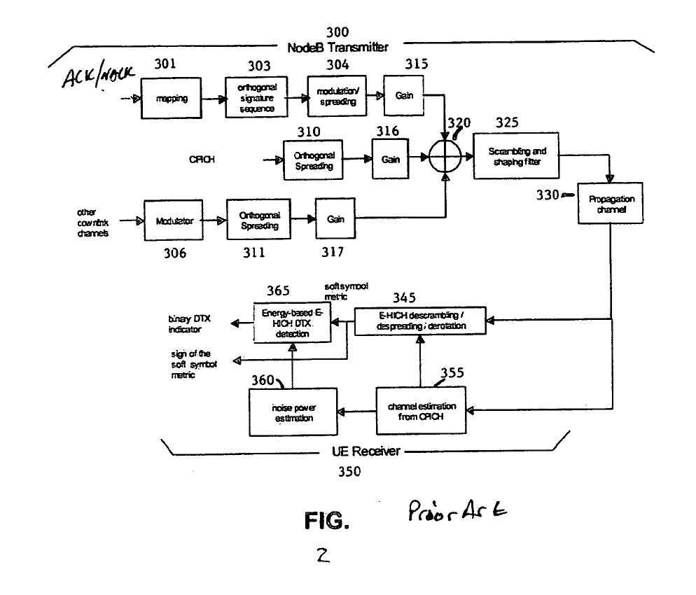

The UE receiver 450 receives a signal such as a signal sent by transmitter 300 shown in FIG. 2. The channel estimation unit 355 uses the CPICH to generate channel estimates, which are generated in any well-known manner. The noise power estimation unit 360 estimates the noise power from the CPICH in a well-known manner. The E-HICH descrambling/despreading/derotation unit 345 de-rotates the E-HICH using the channel estimates according to a well-known manner. The E-HICH descrambling/despreading/derotation unit 345 descrambles, despreads and derotates the E-HICH to generate soft symbol metrics in a manner well-known in the art. The soft symbol metrics are output to the energy-based E-HICH DTX detection unit 365, which also receives the noise power from the noise power estimation unit 360. As is well-known in the art, the E-HICH DTX detection unit 365 may detect the E-HICH by calculating the SIR (which may be the ratio of the square of soft symbol metric over the noise power) and comparing the SIR with a threshold.

According to an example embodiment of the present invention, the energy-based E-HICH DTX detection unit 365 outputs a binary DTX indicator to a buffering device 470. The binary DTX indicator indicates whether ACK information or NACK information was received on the E-HICH.

According to one example embodiment of the present invention as illustrated in FIG. 3, the buffering device 470 includes a controller 479 and a buffer 475 for each non-serving NodeB in the active set.

As shown in FIG. 3, the controller 479 of the buffering device 470 receives active set information in any manner well-known in the art. For example, the controller 479 may receive a list of NodeBs included in the active set from a RNC such as RNCs 130 and 132 illustrated in FIG. 1. Further, the controller 479 may measure the strength of pilot signals received from various NodeBs and report the measurement results to the RNC. As is well-known in the art, the RNC may instruct the controller 479 to modify the list of NodeBs included in the active set based on the measurement results. For example, the RNC may instruct the controller 479 to drop a NodeB from the active set and/or add a NodeB to the active set. The controller 479 identifies which NodeB sent the ACK or NACK information based on a primary scrambling code that is used by each NodeB to differentiate itself from other NodeBs, which is a well-known identification process.

The controller 479 of the buffering device 470 associates a buffer 475 with each non-serving NodeB in the active set. Further, the controller 479 stores ACK information received from a respective non-serving NodeB in the associated buffer 475. For example, the buffering device 470 stores ACK information associated with a first non-serving NodeB in a first buffer 475 and ACK information associated with a second non-serving NodeB in a second buffer 475.

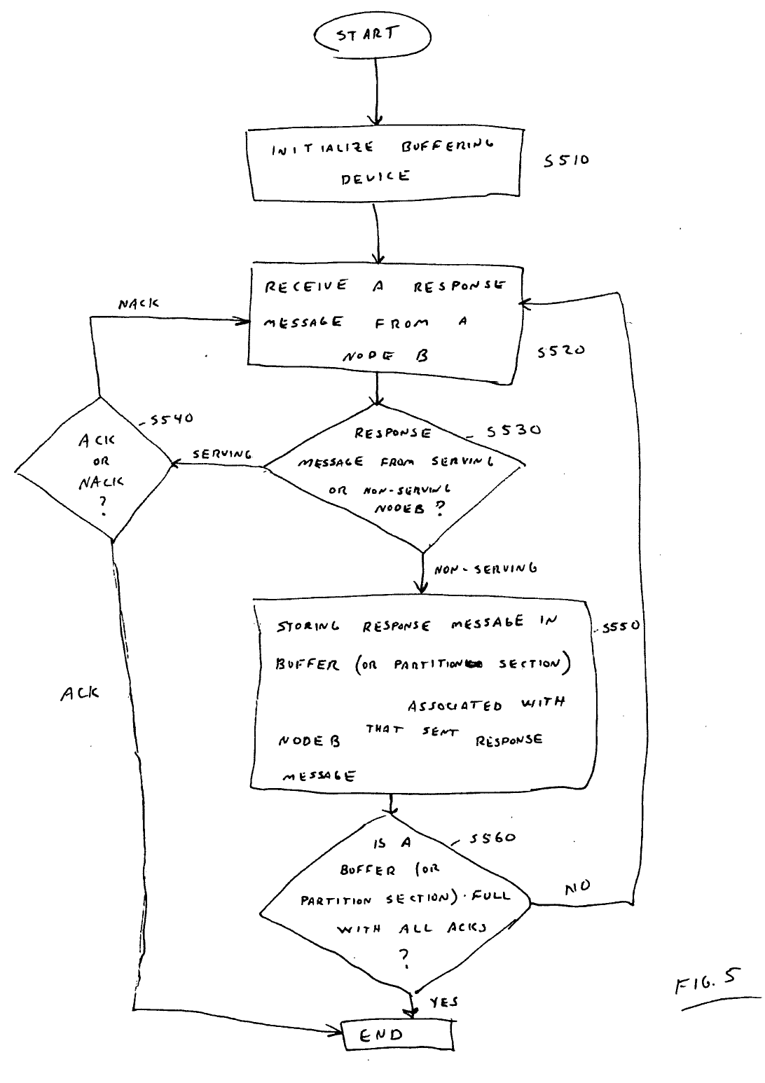

The controller 479 also monitors the status of each buffer 475 and judges whether an E-DCH packet sent by the UE was correctly detected, received and decoded by a non-serving NodeB based on the status of each of the buffers 475. This methodology will be described in detail below with respect to FIG. 5.

As shown in FIG. 3, the buffering device 470 includes a buffer 475 for each non-serving NodeB in the active set. According to an example embodiment of the present invention, the buffer length may be set to any integer value greater than one (e.g., 2).

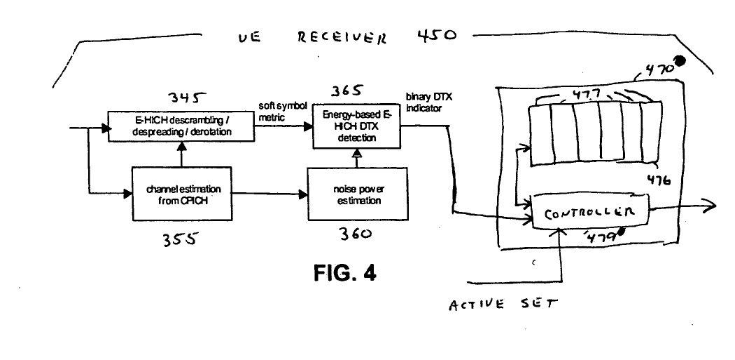

According to another example embodiment of the present invention as shown in FIG. 4, the buffering device 470 includes a controller 479 and a buffer 476.

The controller 479 of the buffering device 470 according to this example embodiment of the present invention partitions the buffer 476 into sections 477. The controller 479 then associates a partitioned section 477 with each non-serving NodeB in the active set. As previously discussed, the active set may be provided and maintained by the controller 479 in any manner well-known in the art. Further, the controller 479 stores ACK information received from a respective non-serving NodeB in the associated partitioned section 477. As previously discussed, the controller 479 may identify which NodeB sent the ACK information based on a primary scrambling code used by the NodeB.

According to this example embodiment of the present invention, the controller 479 monitors the status of each of the partitioned sections 477 and judges whether an E-DCH packet sent by the UE was correctly detected, received and decoded by a non-serving NodeB based on the status of each of the partitioned sections 477. This methodology will be described in detail below with respect to FIG. 5.

FIG. 5 is a flow chart illustrating a method of determining receipt of a sent packet using, for example, a receiver 450 according to an example embodiment of the present invention that includes a buffering device 470.

As shown in FIG. 5, when a UE sends an E-DCH packet, the controller 479 initializes the buffering device 470 in step S510. Initializing the buffering device 470 prepares the buffering device 470 to determine if the sent E-DCH packet is properly received by one of the NodeBs in the active set. Initializing the buffering device 470 may include, for example, initializing each buffer 475 and/or each partition section 477 of the buffering device 470 to all NACKs.

Further, as shown in step S520 of FIG. 5, if the controller 479 of the buffering device 470 receives a response message from a NodeB in response to the sent E-DCH packet, the controller 479 associates the response message with the NodeB that sent the response message based on the primary scrambling code of the NodeB as previously discussed. The response message received in step S520 indicates whether the E-DCH packet sent by the UE was correctly detected, received and decoded by the NodeB. For example, the response message includes ACK or NACK information.

In step S530, the controller 479 determines whether the received response message was sent by the serving NodeB or sent by a non-serving NodeB. If sent by the serving NodeB, then in step S540, the controller 479 determines if the response message is an ACK or NACK. If the controller 479 determines that the received response message corresponds to NACK information, the controller 479 concludes that the serving NodeB did not properly detect, receive and decode the E-DCH packet sent by the UE and the flow chart proceeds back to step S520. Alternatively, if the controller 479 determines that the received response message corresponds to ACK information received from the serving NodeB, the controller 479 concludes that the serving NodeB properly detected, received and decoded the E-DCH packet sent by the UE and the process illustrated in the flow chart of FIG. 5 ends. Once an E-DCH packet is determined as properly detected, received and decoded by the serving NodeB, a new packet may sent by the UE and the process illustrated in FIG. 5 may start another iteration.

Still further, as shown in FIG. 5, if the controller 479 of the buffering device 470 determines in step S530 that a response message was received from a non-serving NodeB in step S520, the received response message (ACK, or silence which is treated as NACK for the non-serving NodeB) is stored in the buffering device 470 in step S550. For example, the controller 479 may store the decoded response message in a buffer 475 (or partitioned section 477) associated with the non-serving NodeB that sent the response message. As previously described, each buffer 475 (or partitioned section 477) may have a fixed length.

In step S560, the controller 479 of the buffering device 470 according to one example embodiment of the present invention detects if a buffer 475 (or partitioned section 477) is full with all ACKs. If the controller 479 detects that none of the buffers 475 (or partitioned sections 477) are full with all ACKs in step S560, the controller 479 proceeds to process another response messages in step S520. However, if the controller 479 detects that a buffer 475 (or partitioned section 477) is full of all ACKs in step S560, the controller 479 determines that the non-serving NodeB corresponding to the full buffer 475 (or partitioned section 477) properly detected, received and decoded the E-DCH packet sent by the UE. Once an E-DCH packet is determined by the controller 479 as properly detected, received and decoded by a non-serving NodeB, a new packet may sent by the UE and the process illustrated in FIG. 5 may start another iteration.

According to an example embodiment of the present invention, the buffer length of each buffer 475 or partitioned section 477 associated with a respective non-serving NodeB may be decided based on a tradeoff between false alarm probability and latency. The false alarm probability may be determined, for example, empirically by a network operator based on system performance requirements. The false alarm probability may be specified by a network operator, for example, at an RNC and may be passed to NodeBs within the network. Latency, as used herein, refers to the amount of time used by the controller 479 to judge that an ACK has been received by a non-serving NodeB. For example, an increase in buffer length will result in increased latency. Further, an increase in latency may result in a decrease in network throughput.

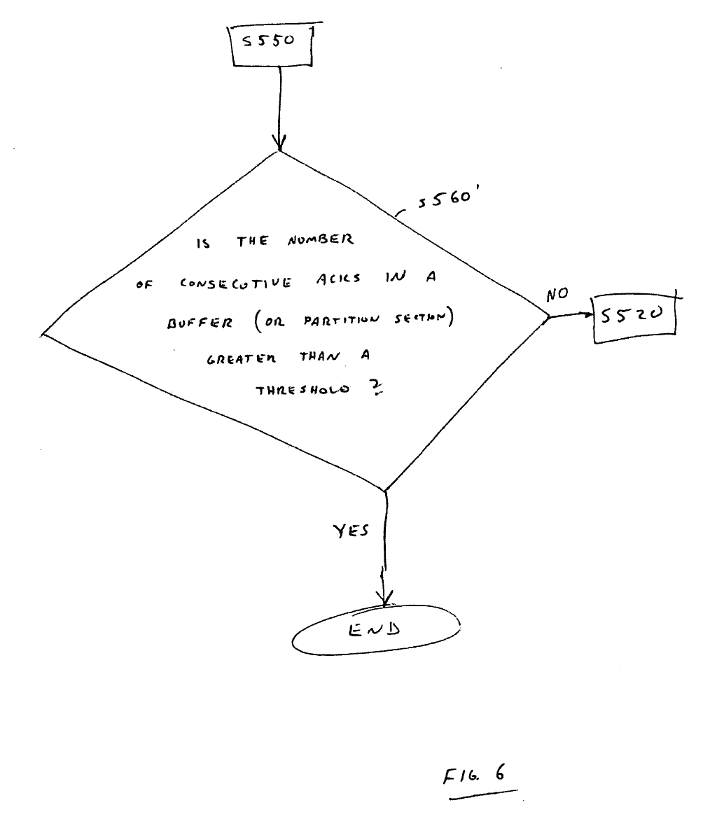

FIG. 6 illustrates an example method of determining receipt of a sent packet, wherein a threshold is used to determine whether a non-serving NodeB correctly detected, received and decoded the sent packet. This method is the same as FIG. 5 except that step S560 has been replaced with step S560′. Accordingly, only the differences from the embodiment of FIG. 5 will be described for the sake of brevity.

As shown in FIG. 6, the controller 479 of the buffering device 470 detects if a buffer 475 (or partitioned section 477) stores a number of consecutive ACKs greater than a threshold (e.g., 2) in step S560′. If the controller 479 detects in step S560′ that none of the buffers 475 (or partitioned sections 477) have a number of consecutive ACKs that is greater than the threshold, the process proceeds to step S520. However, if the controller 479 detects in step S560′ that a buffer 475 (or partitioned section 477) has a number of consecutive ACKs greater than or equal to the threshold, the controller 479 determines that the non-serving NodeB corresponding to the buffer 475 or partitioned section 477 properly detected, received and decoded the E-DCH packet sent by the UE. Once an E-DCH packet is determined by the controller 479 as properly received by a NodeB, a new packet may be sent and the method may start another iteration. Accordingly, in this embodiment, the buffers 475 or partitioned sections 477 may not have a fixed length, and/or may not be full when the E-DCH packet is judged properly detected, received and decoded.

As described above, one or more example embodiments of the present invention may improve detection performance of a receiver. For example, by buffering more than one ACK received from non-serving NodeBs and using the buffered ACKs to determine whether a non-serving NodeB properly received a packet sent from the UE, the probability of false alarm per transmission of a packet is relaxed. Further, by buffering more than one ACK received from non-serving NodeBs and using the buffered ACKs to determine whether a non-serving NodeB properly received a packet sent from the UE, the power on a downlink channel used by a non-serving NodeB to send a response message may be reduced while the probability of a false alarm remains the same as in a conventional receiver. Accordingly, one or more example embodiments of the present invention provide improved system performance and achieve significant capacity gain with a negligible increase in receiver complexity.

Example embodiments of the present invention as described above were discussed with regard to the conventional wireless system of FIG. 1; however, it will be understood that example embodiments of the present invention may be implemented in conjunction with any suitable wireless telecommunications network (e.g., UMTS, CDMA2000, etc.).

Example embodiments of the present invention being thus described, it will be obvious that the same may be varied in many ways. Such variations are not to be regarded as a departure from the invention, and all such modifications are intended to be included within the scope of the invention.

We claim:

1. A method of determining receipt of a sent packet, comprising:
buffering more than one response message received from a non-serving network station in response to the sent packet, each response message indicating whether the non-serving network station properly received the sent packet; and
determining whether the sent packet was properly received based on the buffered response messages.

2. The method of claim 1, wherein the buffering step comprises:
deciding whether a response message is received from a serving network station or non-serving network station to determine if the response message should be buffered.

3. The method of claim 2, wherein the buffering step comprises:
storing response messages from each non-serving network station in a buffer associated with that non-serving network station.

4. The method of claim 3, wherein the buffer has a fixed length.

5. The method of claim 4, wherein the fixed length is two.

6. The method of claim 3, wherein the determining step determines the sent packet was properly received by a non-serving network station if the buffer corresponding to the non-serving network station is full of response messages indicating the sent packet was properly received.

7. The method of claim 3, wherein the determining step determines the sent packet was properly received by a non-serving network station if one of the buffers stores a number of consecutive response messages indicating the sent packet was properly received equal to a threshold value.

8. The method of claim 7, wherein the threshold value is two.

9. The method of claim 3, further comprising:
initializing each buffer if the determining step determines the sent packet was properly received.

10. The method of claim 3, wherein the buffering step comprises:
partitioning a buffer into a plurality of sections, each section corresponding to a non-serving network station; and
storing response messages from each non-serving network station in the section associated with that non-serving network station.

11. The method of claim 10, wherein each section has a fixed length.

12. The method of claim 11, wherein the fixed length is two.

13. The method of claim 10, wherein the determining step determines the sent packet was properly received by a non-serving network station if the section corresponding to the non-serving network station is full of response messages indicating the sent packet was properly received.

14. The method of claim 10, wherein the determining step determines the sent packet was properly received by a non-serving network station if one of the sections stores a number of consecutive response messages indicating the sent packet was properly received equal to a threshold value.

15. The method of claim 14, wherein the threshold value is two.

16. The method of claim 1, further comprising:
controlling transmission of a new packet based on results of the determining step.

17. An apparatus for determining receipt of a sent packet, comprising:
a buffering device buffering more than one response message received from a non-serving network station in response to the sent packet and determining whether the sent packet was properly received based on the buffered response messages.

18. The apparatus of claim 17, wherein the buffering device comprises:
a buffer associated with each non-serving network station, and
a controller storing a response message in the buffer associated with the non-serving network station that sent the response message, monitoring response messages in each buffer, and determining whether the sent packet was properly received based on the response messages in each buffer.

19. The apparatus of claim 17, wherein the buffering device comprises:
a buffer that is partitioned into a plurality of sections, each section associated with each non-serving network station, and
a controller storing a response message in the section associated with the non-serving network station that sent the response message, monitoring the response messages in each buffer, and determining whether the sent packet was properly received based on the response messages in each buffer.
